(19) United States
(12) Patent Application Publication
(10) Pub. No.: US 2015/0227105 A1
(43) Pub. Date: Aug. 13, 2015

(54) IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Nobuyuki MIYOSHI, Shimizu Shizuoka (JP)

(21) Appl. No.: 14/575,719

(22) Filed: Dec. 18, 2014

(30) Foreign Application Priority Data
Feb. 10, 2014 (JP) 2014-23197

(51) Int. Cl. G03G 15/00

(52) U.S. Cl. CPC G03G 15/70

(57) ABSTRACT

According to an embodiment, the image forming apparatus includes a fixing unit. When a sheet becomes the jam state in the position of any one of the fixing unit and the vicinity of the fixing unit, the fixing unit heats a toner image formed on the sheet in the jam state at the decolorizing temperature.

### CROSS-REFERENCE TO RELATED APPLICATION

This application is based upon and claims the benefit of priority from the prior Japanese Patent Application No. 2014-23197, filed on Feb. 10, 2014, the entire contents of which are incorporated herein by reference.

### FIELD

The embodiment described here relates generally to an image forming apparatus capable of using a reuse sheet.

### BACKGROUND

The image forming apparatus that performs a copy and the like of an image of a document and the like to a sheet is widely spread. The image forming apparatus of this type conveys a sheet to the transfer unit, and forms a toner image by making the toner adhere to this sheet in the transfer unit. The image forming apparatus further conveys the sheet to the fixing unit, and fixes the toner image to the sheet by heating and fusing the toner image in the fixing unit. Therefore, in the image forming apparatus, a mechanism configured to convey a sheet smoothly is important. However, this conveyance mechanism is a mechanical portion, and therefore, sometimes jam of a sheet occurs during the conveyance of the sheet, particularly in the process of the toner adhesion and the fixing to the sheet, in the conveyance mechanism.

When jam of a sheet occurs, it is necessary to remove the sheet that caused the jam from the conveyance mechanism by hand. However, the toner is adhered to the sheet that caused the jam. The toner adhering to this sheet is usually in a state where the toner is not fixed to the sheet completely. For this reason, when the operator removes the sheet in a state where the toner adheres to by hand from the conveyance mechanism, the operator's hand is soiled. In the case of jam of color printing in particular, soiling of the operator's hand is remarkable. Even in the case of jam of black-and-white printing, colored toner is attached to the operator's hand, and it causes discomfort to the operator.

### BRIEF DESCRIPTION OF THE DRAWINGS

FIG. 1 is a sectional view showing a main part of an image forming apparatus according to a first embodiment;

FIG. 2 is a diagram illustrating an exemplary configuration of a fixing unit and a jam detection unit used in the image forming apparatus according to the first embodiment;

FIG. 3 is a flowchart illustrating processing for controlling the image forming apparatus according to the first embodiment;

FIG. 4 is a diagram illustrating an exemplary configuration of a fixing unit and a jam detection unit used in the image forming apparatus according to a second embodiment; and

FIG. 5 is a flowchart illustrating a process for controlling the image forming apparatus according to the second embodiment.

### DETAILED DESCRIPTION

According to the embodiment, the image forming apparatus includes a fixing unit, a jam detection unit, and a controller. The fixing unit performs processing for fixing the toner image to a sheet by heating a toner image formed on the sheet at the fixing temperature, and processing for decolorizing the toner image by heating the toner image formed on the sheet at the decolorizing temperature higher than the fixing temperature. The jam detection unit detects that the sheet is jammed in the fixing unit and the vicinity of the fixing unit. When the jam state of the sheet is detected by the jam detection unit, the controller raises the heating temperature of the fixing unit to the decolorizing temperature, and decolorizes the toner image formed on the jammed sheet by the fixing unit.

In the following, a further embodiment will be described with reference to the drawings. In the drawings, the same reference numerals indicate the identical or similar parts.

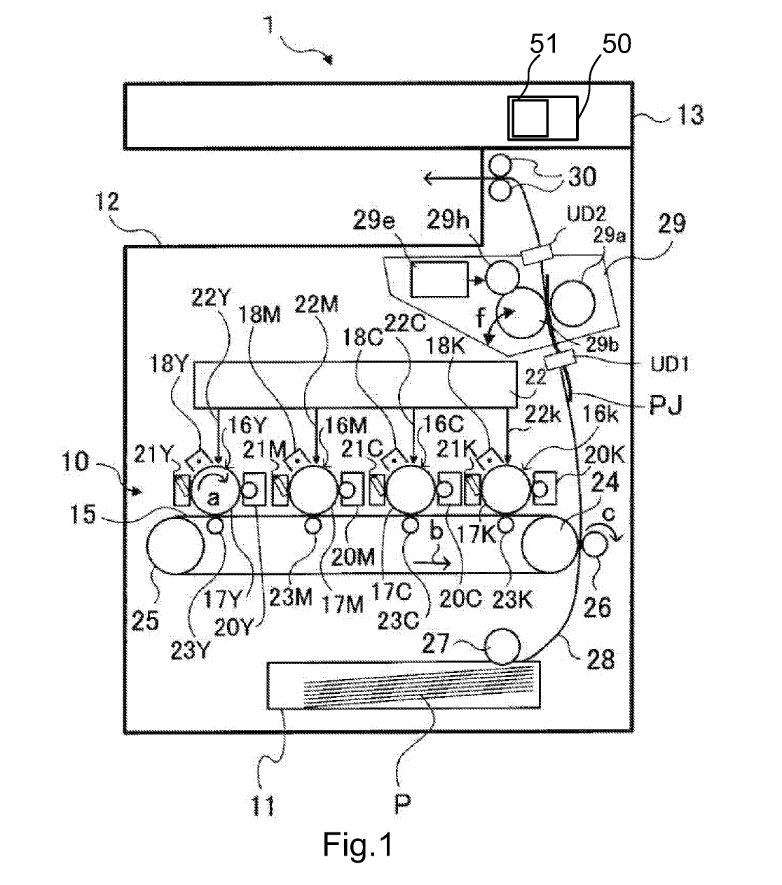

The image forming apparatus according to the first embodiment will be described with reference to FIG. 1. FIG. 1 is a cross-sectional view showing a main part of an image forming apparatus according to a first embodiment. The image forming apparatus illustrated in FIG. 1 is an MFP (Multi-Functional Peripheral) 1 capable of printing a color image. As shown in FIG. 1, the MFP 1 includes a printer device 10, a paper feeding device 11, a paper discharging device 12, and a scanner device 13. The scanner device 13 obtains an image data by optically scanning the image of the original. The MFP 1 can also obtain an image data from an external device via the network, other than the scanner device 13. The MFP 1 prints the image on a recording medium, for example, a sheet based on the image data, using four colors, Y (yellow), M (magenta), C (cyan), and K (black), of decolorizable toner. The MFP 1 performs the fixing processing configured to fix the toner image formed on the sheet and the decolorizing processing configured to decolorize the toner image already printed on the sheet for reuse by operating a fixing unit 29 described below.

The printer device 10 includes a transfer unit configured to form a toner image on a sheet. The transfer unit includes an intermediate transfer belt 15, primary transfer rollers 23Y, 23M, 23C, and 23K, and a secondary transfer roller 26. The printer device 10 includes four image forming stations 16Y, 16M, 16C, and 16K respectively for Y, M, C, and K which are disposed in parallel along the intermediate transfer belt 15 as in FIG. 1. Each of the image forming stations 16Y, 16M, 16C, and 16K includes a corresponding one of photoconductor drums 17Y, 17M, 17C, and 17K.

Each of the image forming stations 16Y, 16M, 16C, and 16K further includes a corresponding one of chargers 18Y, 18M, 18C, and 18K, a corresponding one of developing units 20Y, 20M, 20C, and 20K, and a corresponding one of photoconductor cleaners 21Y, 21M, 21C, and 21K. The chargers 18Y, 18M, 18C, and 18K, the developing units 20Y, 20M, 20C, and 20K, and the photoconductor cleaners 21Y, 21M, 21C, and 21K are respectively disposed in this order around the photoconductor drums 17Y, 17M, 17C, and 17K rotating in the direction of the arrow a (in clockwise direction). The chargers 18Y, 18M, 18C, and 18K uniformly charge the photoconductor drums 17Y, 17M, 17C, and 17K. The developing units 20Y, 20M, 20C, and 20K respectively contain the toners of Y, M, C, and K. Each of the developing units 20Y, 20M, 20C, and 20K supplies a corresponding one of the photoconductor drums 17Y, 17M, 17C, and 17K on which an electrostatic latent image is formed by a laser exposure unit 22 described below with the toners of Y, M, C, and K. The developing units 20Y, 20M, 20C, and 20K develop the electrostatic latent image by supplying the toners of Y, M, C, and K, respectively. The developing units 20Y, 20M, 20C, and 20K form toner images of Y, M, C, and K on the respective photoconductor drums 17Y, 17M, 17C, and 17K by developing the electrostatic latent images. The toner images are transferred onto the intermediate transfer belt 15. The photoconductor cleaners 21Y, 21M, 21C, and 21K remove the toners remaining on the respective photoconductor drums 17Y, 17M, 17C, and 17K from the respective photoconductor drums after the transfer of the toner images. The printer device 10 further includes the laser exposure unit 22.

The laser exposure unit 22 irradiates each of the photoconductor drums 17Y, 17M, 17C, and 17K charged by a corresponding one of the chargers 18Y, 18M, 18C, and 18K with the laser light beams 22Y, 22M, 22C, and 22K corresponding to the respective colors in accordance with the image data. The laser exposure unit 22 exposes each of the photoconductor drums 17Y, 17M, 17C, and 17K by irradiating a corresponding one of the laser light beams 22Y, 22M, 22C, and 22K. The laser exposure unit 22 forms electrostatic latent images on the respective photoconductor drums 17Y, 17M, 17C, and 17K by performing exposure.

The printer device 10 includes a backup roller 24 and a driven roller 25 so as to support the intermediate transfer belt 15. The backup roller 24 and the driven roller 25 support the intermediate transfer belt 15 so that the intermediate transfer belt 15 travels in the direction of the arrow b. The primary transfer rollers 23Y, 23M, 23C, and 23K of the transfer unit are disposed in the positions opposed to the respective photoconductor drums 17Y, 17M, 17C, and 17K (primary transfer positions) via the intermediate transfer belt 15.

Each of the primary transfer rollers 23Y, 23M, 23C, and 23K primarily transfers a toner image formed on a corresponding one of the photoconductor drums 17Y, 17M, 17C, and 17K to the intermediate transfer belt 15. When the MFP 1 prints a color image, each of the primary transfer rollers 23Y, 23M, 23C, and 23K primarily transfers the toner images of Y, M, C, and K formed on a corresponding one of the photoconductor drums 17Y, 17M, 17C, and 17K to the intermediate transfer belt 15 by superimposing them sequentially. As described above, each of the photoconductor cleaners 21Y, 21M, 21C, and 21K removes the toner remaining on a corresponding one of the photoconductor drums 17Y, 17M, 17C, and 17K after the primary transfer.

The secondary transfer roller 26 of the transfer unit is disposed in a position opposed to the backup roller 24 (secondary transfer position) via the intermediate transfer belt 15. The secondary transfer roller 26 rotates in the direction of the arrow c (clockwise direction), for example, being driven by the intermediate transfer belt 15. The paper feeding device 11 includes a cassette configured to store the sheet P and a pickup roller 27. The pickup roller 27 takes out the sheet P from the cassette of the paper feeding device 11. The printer device 10 includes a conveyance path 28. The conveyance path 28 feeds the taken-out sheet P to the secondary transfer position in the timing at which the toner image of the intermediate transfer belt 15 reaches the position of the secondary transfer roller 26.

When the toner image on the intermediate transfer belt 15 is secondarily transferred to the sheet P, the printer device 10 applies the transfer bias to between the intermediate transfer belt 15 and the secondary transfer roller 26. The secondary transfer roller 26 forms a nip between the secondary transfer roller 26 and the intermediate transfer belt 15, and sandwiches the sheet P in this nip, conveying the sheet P. The secondary transfer roller 26 secondarily transfers the toner image on the intermediate transfer belt 15 to the sheet P in a lump while conveying the sheet P.

The printer device 10 includes the fixing unit 29. When the MFP 1 prints the toner image on the sheet P being a recording medium, the fixing unit 29 fixes the toner image on the sheet P by heating the toner image at a fixing temperature. Furthermore, when the MFP 1 decolorizes the toner image already printed on the sheet P, the fixing unit 29 decolorizes the toner image by heating the toner image at a decolorizing temperature. The MFP 1 includes a paper discharging roller 30. The paper discharging roller 30 includes a pair of rollers. The paper discharging roller 30 is disposed at the end of the conveyance path 28. The paper discharging roller 30 discharges the sheet P having passed through the fixing unit 29 to the outside of the MFP 1. The paper discharging device 12 receives and supports the sheet P discharged by the paper discharging roller 30. The fixing unit 29 includes a press roller 29a, a fixing roller 29b, a heat electrical circuit 29e, and a heat roller 29h. The press roller 29a makes contact with the fixing roller 29b, and forms a nip between the press roller 29a and the fixing roller 29b. The press roller 29a applies pressure from the back face of the sheet P (the face on which the toner image is not formed) in the nip. The heat electrical circuit 29e heats the heat roller 29h. The heat roller 29h is disposed in contact with the fixing roller 29b. The heat roller 29h transmits heat to the fixing roller 29b. The fixing roller 29b heats the toner image on the sheet P by the heat transmitted from the heat roller 29h. The fixing roller 29b heats the toner image from the front face of the sheet P at a temperature of any one of the fixing temperature and the decolorizing temperature in the nip.

The temperature of the heat roller 29h is regulated and controlled by the heat electrical circuit 29e. When the MFP 1 prints a toner image on the sheet P, the heat electrical circuit 29e heats the heat roller 29h so that the fixing roller 29b reaches the fixing temperature required to fix the toner.

As described above, the fixing unit 29 according to the first embodiment includes the heat roller 29h which generates heat aside from the fixing roller 29b, and transmits the heat generated by the heat roller 29h to the fixing roller 29b. On the other hand, the fixing unit 29 may be configured only with a fixing roller abutting the front face of the sheet on which a toner image is formed, configured to fix a toner image by applying heat to the toner image, and a press roller configured to apply pressure from the back face of the recording medium. In this case, the fixing roller generates heat directly.

The MFP 1 completes the printing of the image by fixing a toner image to the sheet P by the fixing unit 29. The MFP 1 discharges the sheet P on which an image is printed to the paper discharging device 12 by the paper discharging roller 30 as described above.

The MFP 1 is not limited to the tandem system where the image forming stations 16Y, 16M, 16C, and 16K are disposed in parallel along the intermediate transfer belt 15. In the MFP 1, the number of the developing unit is not limited either. The MFP 1 may be an apparatus of the direct transfer system where the toner image is directly transferred from the photoconductor drums onto the sheet being a recording medium.

The MFP 1 also includes a decolorizing mode of operating only the decolorizing function in addition to the mode of printing images as described above (printing mode). The term “decolorizing function” means a function for executing processing for decolorizing the toner image already printed on the sheet P using the decolorizable color material, for example, the decolorizable toner. The decolorizable color material may be, for example, the decolorizable ink. The MFP 1 includes a control panel 50 that accepts the selection, etc. of any one of the printing mode and the decolorizing mode by the operator. The control panel 50 includes the display 51 configured to display the jam state of the sheet, which will be described below. When operating the decolorizing function of the MFP 1, the operator selects a decolorizing mode by operating the control panel 50 of the MFP 1. Furthermore, the operator places the sheet P that is printed using decolorizable toners in a cassette of the paper feeding device 11, and instructs the start of the decolorizing mode by operating the control panel 50 in the MFP 1. When the control panel 50 in the MFP 1 accepts the selection of the decolorizing mode by the operator, and accepts an instruction to start the decolorizing mode, the pickup roller 27 takes out the sheet P from the paper feeding cassette device 11 to convey to the conveyance path 28. The MFP 1 conveys this sheet to the fixing unit 29 through the conveyance path 28. The heat electrical circuit 29e of the fixing unit 29 makes the heat roller 29h heat to the temperature at which the decolorizable toner is decolorized (decolorizing temperature). The heated heat roller 29h transmits heat to the fixing roller 29b so that the temperature of the fixing roller 29b reaches the decolorizing temperature. The fixing roller 29b decolorizes the toner image by heating the toner image printed on the sheet P to the decolorizing temperature while sandwiching the sheet P in the nip between the fixing roller 29b and the press roller 29a, and conveying the sheet P. The sheet P on which the toner image is decolorized can be reused as the sheet for printing.

By the way, as described above, the MFP 1 conveys the sheet P through the conveyance path 28 so as to perform printing by the printer device 10 using the sheet P stored in the cassette of the paper feeding device 11. At this time, the sheet P sometimes becomes the jam state in the middle position of the conveyance path 28, specifically in a place where the fixing is performed. The term “jam state” means a state where the sheet P is stopped in the middle of the conveyance path 28, and, for example, where the sheet P is deformed. In the following, a sheet that becomes the jam state is referred to as a sheet PJ.

For example, a jammed sheet PJ that becomes the jam state at the point of performing the fixing is caught between the press roller 29a and the fixing roller 29b, and is not conveyed properly by being deformed. The fixing roller 29b is rotatably supported in the direction of arrow f in FIG. 1 so that the operator can release the jam state. When the jam state occurs in the MFP 1, the operator rotates the fixing roller 29b in the direction of widening the gap between the fixing roller 29b and the press roller 29a by operating the operation lever (not shown). The operator removes the sheet PJ from between the fixing roller 29b and the press roller 29a by rotating the fixing roller 29b. The operator can release the jam state in the MFP 1 by removing the sheet PJ.

The MFP 1 according to the first embodiment makes the heat roller 29h heat to the decolorizing temperature that is higher than the fixing temperature at the time of fixing by the heat electrical circuit 29e before the operator rotates the fixing roller 29b so as to release the above jam state. The heat roller 29h transmits heat to the fixing roller 29b so that the temperature of the fixing roller 29b reaches the decolorizing temperature that is higher than the fixing temperature at the time of fixing. The fixing roller 29b decolorizes the toner image by heating the toner image formed on the sheet PJ to the decolorizing temperature as described above. By being decolorized, the toner image becomes colorless.

As described above, the toner of the sheet PJ can become colorless by the heat roller 29h of the fixing unit 29 heating to the high temperature (decolorizing temperature). Therefore, when the operator removes the sheet PJ from the MFP 1, it is possible to reduce the visual discomfort for the operator.

The MFP 1 includes infrared detectors UD1 and UD2 configured to detect that the sheet P becomes the jam state. The infrared detector UD1 is disposed in the inlet portion through which the sheet enters the fixing unit 29 in the conveyance path 28. The infrared detector UD2 is disposed in the outlet portion through which the sheet exits from the fixing unit in the conveyance path 28. The infrared detectors UD1 and UD2 detect that the sheet becomes the jam state in the fixing unit 29 and the vicinity of the fixing unit 29 by being disposed in the inlet portion and the outlet portion of the fixing unit 29.

The MFP 1 includes a plurality of conveyance roller pairs (not shown) as a sheet conveyance device so as to convey the sheet P along the conveyance path 28. The sheet P that becomes the jam state is also detected by the conveyance roller pairs. Specifically, the conveyance roller pairs include a jam detection unit that detects the sheet P. Furthermore, the distance between the adjacent conveyance roller pairs is determined. The time when the sheet P is conveyed between the conveyance roller pairs in normal conveyance speed (normal conveyance time) is also known in advance. Therefore, when the leading edge of the sheet P is not detected in the next conveyance roller pairs at the downstream even at this normal conveyance time, the MFP 1 judges that the sheet is in a state of not being conveyed for some reason, in other words the sheet P becomes the jam state. For example, the MFP 1 judges the actual conveyance time of the sheet P by detecting the sheet P by the jam detection unit. THE MFP 1 judges that the sheet P is in the jam state by comparing the actual conveyance time and the normal conveyance time. In the following, sometimes it is simply referred to as a jam state that the sheet P is in the jam state.

As described above, by detecting the jam state by the conveyance roller pairs, there is an advantage that a special device for detecting the jam becomes unnecessary in the MFP 1.

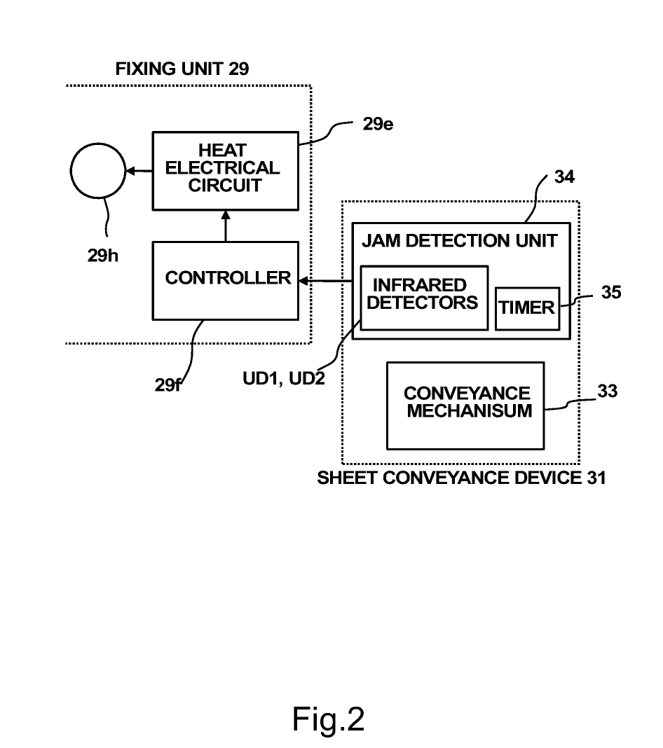

In the following, a specific exemplary configuration for detecting the jam state of the sheet P and processing after detecting the jam state will be described with reference to FIG. 2. FIG. 2 is a diagram illustrating an exemplary configuration of the fixing unit 29 and a sheet conveyance device 31 used in the MFP 1. As illustrated in FIG. 2, the MFP 1 includes a conveyance mechanism 33 and a jam detection unit 34 as the sheet conveyance device 31. The conveyance mechanism 33 includes a plurality of conveyance roller pairs disposed along the conveyance path 28 and a drive circuit (not shown) configured to drive rotationally these conveyance roller pairs. The jam detection unit 34 detects the passage of the sheet P in the conveyance roller pairs. The jam detection unit 34 includes a timer 35 configured to measure the conveyance time of the sheet P. The jam detection unit 34 includes the infrared detectors UD1 and UD2. The jam detection unit 34 is connected to the controller 29f.

On the other hand, the fixing unit 29 in the MFP 1 includes the heat electrical circuit 29e and the controller 29f described above as illustrated in FIG. 2. The controller 29f performs the control and the like of the heating temperature of the fixing unit 29. Specifically, the controller 29f controls the heat operation of the heat electrical circuit 29e. The heat electrical circuit 29e changes the heat generation temperature of the heat roller 29h by being controlled by the controller 29f. The heating temperature by the fixing roller 29b described above is changed by the heat generation temperature of the heat roller 29h being changed. On the sheet P, there are cases where decolorizable color images are printed and where non-decolorizable color images are printed.

When decolorizing the decolorizable color image printed on the sheet P, the controller 29f controls the heat electrical circuit 29e so that the heat generation temperature of the heat roller 29h becomes the decolorizing temperature higher than the fixing temperature in the case of printing. Heat of the heat roller 29h is transmitted to the fixing roller 29b. Therefore, the fixing roller 29b decolorizes the decolorizable color image by heating at the decolorizing temperature.

As described above, the MFP 1 detects the jam state by using the jam detection unit 34. The MFP 1 judges where the jam state occurs by the detection result of the jam state. When the MFP 1 judges that the place where the jam occurs is close to the fixing unit 29, the controller 29f raises the heating temperature of the fixing roller 29b up to the decolorizing temperature via the heat roller 29h by controlling the heat electrical circuit 29e. The fixing roller 29b decolorizes the image printed on the sheet P by heating the image at the decolorizing temperature while sandwiching and conveying the sheet P in the nip between the fixing roller 29b and the press roller 29a.

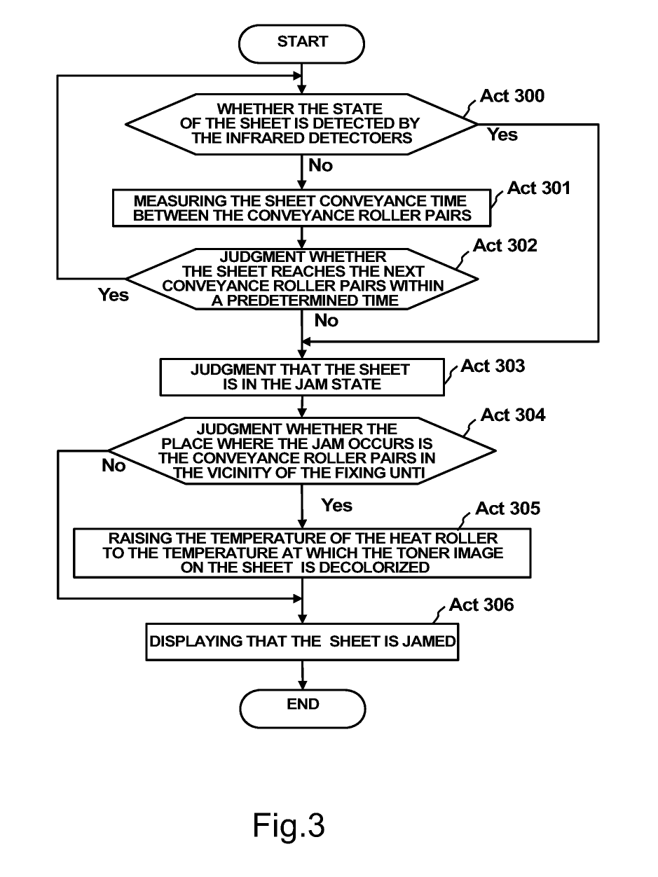

In the following, the decolorizing processing on the sheet P that is in the jam state will be described with reference to FIG. 3. FIG. 3 is a flowchart illustrating processing for controlling the MFP 1. For example, when the MFP 1 is conveying the sheet P for printing, as illustrated in FIG. 3, in Act 300, the infrared detectors UD1 and UD2 detect whether the sheet remains in the fixing unit 29 or the vicinity of the fixing unit 29. In other words, the infrared detectors UD1 and UD2 detect whether the sheet P is not in the jam state in the fixing unit 29 and the vicinity of the fixing unit 29. When the infrared detectors UD1 and UD2 detect that the sheet P is in the jam state, the processing of the MFP 1 proceeds to Act 303 described below. When the infrared detectors UD1 and UD2 do not detect that the sheet P is in the jam state, the processing of the MFP 1 proceeds to Act 301.

In Act 301, the MFP 1 detects the conveyance passing place of the sheet, and measures the conveyance time in which the sheet passes through the adjacent conveyance roller pairs by using the conveyance roller pairs disposed along the conveyance path 28 in the sheet conveyance mechanism 33. Specifically, the jam detection unit 34 in the sheet conveyance device 31 detects the conveyance passing place of the sheet. The timer 35 measures the conveyance time of the sheet P passing through the adjacent conveyance roller pairs based on the detection result of the jam detection unit 34. The sheet P is conveyed by the sheet conveyance mechanism 33.

In Act 302, the controller 29f in the MFP 1 judges whether the sheet P reaches the next conveyance roller pairs at the downstream within a predetermined time (normal conveyance time). Specifically, by the timer 35 measuring the conveyance time of the sheet P as described above, the controller 29f detects whether the sheet P arrives at the next conveyance roller pairs at the downstream within the normal conveyance time. When the measured conveyance time by the timer 35 is within the normal conveyance time (YES in Act 302), the controller 29f in the MFP 1 judges that the sheet P is normally conveyed. Thus, the processing of the MFP 1 returns to Act 301. In the above Act 301, the MFP 1 measures the conveyance time of the next sheet P.

On the other hand, when the sheet P does not reach the adjacent conveyance roller pairs at the downstream within the normal conveyance time, in other words when the measured conveyance time by the timer 35 is not within the normal conveyance time (NO in Act 302), the processing in the MFP 1 proceeds to Act 303. In Act 303, the controller 29f in the MFP 1 judges that the sheet P is not normally conveyed. In other words, the MFP 1 detects that the jam state occurs. Specifically, as described above, the jam detection unit 34 including the timer 35 inside detects whether the sheet is normally conveyed. The conveyance mechanism 33 in the sheet conveyance device 31 controls the conveyance of the sheet P by driving all the roller pairs disposed in the conveyance path 28. The jam detection unit 34 detects the jam state of the sheet P in each section of the adjacent roller pairs in the conveyance path 28.

In the above Act 303, when the controller 29f in the MFP 1 judges that the jam state occurs by the detection result of the jam detection unit 34, the processing of the MFP 1 proceeds to Act 304. In Act 304, the controller 29f of the MFP 1 further judges whether the place where the jam occurs is the conveyance roller pairs in the vicinity of the fixing unit 29. Specifically, the jam detection 34 detects the place where the jam state occurs in cooperation with the conveyance mechanism 33 in the sheet conveyance device 31.

In the above Act 304, when the controller 29f of the MFP 1 judges that the generation place of the jam state is the roller pairs in the vicinity of the fixing unit 29 (YES in Act 304) by the detection result of the jam detection unit 34, the processing of the MFP 1 proceeds to Act 305. In Act 305, the MFP 1 raises the heat generation temperature of the heat roller 29h to the temperature at which the decolorizing toner is decolorized by the heat electrical circuit 29e.

Specifically, when the jam detection unit 34 detects that the sheet P in the vicinity of the fixing unit 29 becomes the jam state, the controller 29f gives instructions for heating the heat generation temperature of the heat roller 29h to a high temperature to the heat electrical circuit 29e. The heat electrical circuit 29e heats the heat roller 29h based on the instructions of the controller 29f so that the heat generation temperature of the heat roller 29h reaches the decolorizing temperature or above. The heat roller 29h sets the temperature of the fixing roller 29b to the decolorizing temperature by transmitting heat to the fixing roller 29b. In other words, the controller 29f sets the temperature of the fixing roller 29b to the decolorizing temperature via the heat roller 29h by controlling the heat electrical circuit 29e. In the above Act 305, when the MFP 1 raises the heat generation temperature of the heat roller 29h to the decolorizing temperature by the heat electrical circuit 29e, the processing of the MFP 1 proceeds to Act 306. In Act 306, the MFP 1 displays that the sheet p is jammed in the MFP 1, in other words, that the MFP 1 becomes jammed on the display 51 of the control panel 50 so as to prompt the operator to remove the sheet PJ (sheet P in the jam state) from the MFP 1.

On the other hand, in the above Act 304, when the controller 29f of the MFP 1 judges that the generation place of the jam state is not in the vicinity of the fixing unit 29 by the detection result of the jam detection unit 34 (NO in Act 304), the processing of the MFP 1 proceeds to the above Act 306. As described above, in the above Act 306, the controller 29f of the MFP 1 prompts the operator to remove the sheet PJ from the MFP 1 by displaying on the display 51 that the sheet P is jammed. When the place where the jam state occurs is not in the vicinity of the fixing unit 29, the toner is not adhered to the sheet PJ yet (the toner image is not formed), or the toner image is fixed on the sheet PJ completely. For this reason, when the operator removes the sheet PJ from the MFP 1, the unfixed toner is not adhered to the hand of the operator. Therefore, when the place where the jam state occurs is not in the vicinity of the fixing unit 29, the controller 29f of the MFP 1 does not perform the processing of making the heat roller 29h heat to the decolorizing temperature or above such as in Act 305.

According to the first embodiment described above, when the sheet becomes the jam state in the vicinity of the fixing unit, the MFP capable of printing a color image decolorizes the toner image on the sheet in the jam state by heating the toner image to the decolorizing temperature. Therefore, it is possible to reduce the discomfort of the operator when the operator removes the sheet in the jam state from the MFP 1.

In the following, the second embodiment will be described. In the above first embodiment, as an image forming apparatus, the configuration of the MFP 1 capable of printing a color image is described. However, the image forming apparatus may be an apparatus configured to print a monochrome image. The image forming apparatus may be a printer having only a printing function, or a copying machine having only a copying function. Furthermore, in the above first embodiment, as the fixing unit 29 in the image forming apparatus, the configuration that heats the heat roller 29h by the heat electrical circuit 29e (induction heating circuit, for example), and heats the fixing roller 29b by this heat roller 29h is described. However, the fixing unit 29 in the image forming apparatus may include a lamp inside the heat roller as a heat source, and may have a configuration configured to heat the heat roller directly, without using the heat electric circuit, by this inside lamp. Furthermore, the fixing unit 29 in the image forming apparatus may include a lamp inside the fixing roller as a heat source, and may have a configuration configured to heat the fixing roller directly, without using the heat electric circuit and the heat roller, by this inside lamp.

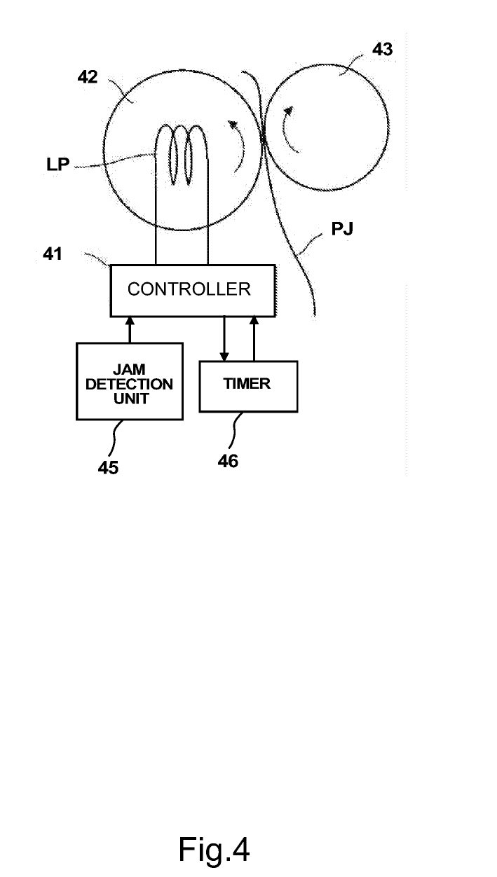

The image forming apparatus according to the second embodiment includes the same configuration as the MFP 1 according to the first embodiment illustrated in FIG. 1 except for a fixing unit 29 and a sheet conveyance device 31. The fixing unit 29 and the sheet conveyance device 31 in an MFP 1 according to the second embodiment will be described with reference to FIG. 4. FIG. 4 is a diagram showing an exemplary configuration of the main portion of the image forming apparatus according to the second embodiment. As shown in FIG. 4, the fixing unit 29 includes a fixing roller 42. The fixing roller 42 incorporates a heater lamp LP being a heat source. The fixing roller 42 is directly heated by this heater lamp LP. The fixing unit 29 in the second embodiment includes a controller 41. The controller 41 performs the control and the like of the heating temperature of the fixing unit 29. Specifically, the controller 41 controls the heater lamp LP by turning it on and off so that the temperature of the fixing roller 42 reaches the fixing temperature or the decolorizing temperature. The fixing unit 29 includes a press roller 43. The press roller 43 makes a contact with the fixing roller 42, and forms a nip between the press roller 43 and the fixing roller 42. The fixing roller 42 and the press roller 43 sandwich the sheet P in the nip, conveying a sheet P. When conveying the sheet P, the fixing roller 42 abuts the front face of the sheet P on which the toner image is formed, and heats the toner image at a temperature of any one of the fixing temperature and the decolorizing temperature. When conveying the sheet P, the press roller 43 pressurizes the sheet from the back face of it. The fixing unit 29 and the sheet conveyance device 31 in the MFP 1 according to the second embodiment include a jam detection unit 45 and a timer 46 as shown in FIG. 4. The jam detection unit 45 detects the jam state of the sheet P. The timer 46 measures the predetermined time described below. The jam detection unit 45 and the timer 46 are connected to the controller 41. The jam detection unit 45 may detect the jam state of the sheet P by comparing the actual conveyance time and the normal conveyance time of the sheet between the roller pairs in a conveyance path 28, in the same manner as the above first embodiment, for example.

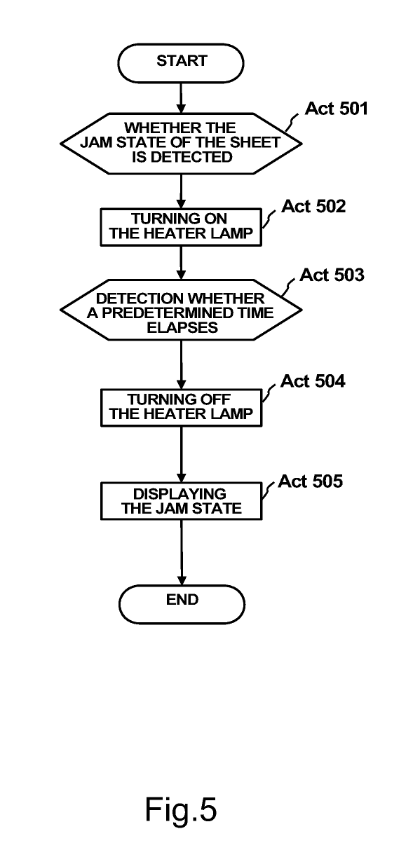

In the following, the decolorizing processing on the sheet P in the jam state will be described with reference to FIG. 5. FIG. 5 is a flowchart illustrating the processing for controlling the MFP 1 according to the second embodiment. For example, when the MFP 1 conveys the sheet P by starting the operation for the printing, in Act 501, the jam detection unit 45 detects whether the sheet P on which the toner image is transferred is in the jam state. The toner image is formed by, for example, the black toner that is decolorized at the decolorizing temperature higher than the fixing temperature. In Act 501, when detecting that the sheet P is in the jam state, the jam detection unit 45 further detects whether the place where the jam state occurs is in the vicinity of the fixing unit 29. The jam detection unit 45 detects only the jam state in the vicinity of the fixing unit 29. In Act 501, when the jam detection unit 45 detects the jam state in the vicinity of the fixing unit 29, the processing of the MFP 1 proceeds to Act 502. In Act 502, the controller 41 turns on the heater lamp LP so as to heat the fixing temperature to a temperature higher than the fixing temperature. The heater lamp LP heats the fixing roller 42 to a temperature further higher than the normal fixing temperature.

The timer 46 starts the time measurement, for example, from the time when the controller 41 turns on the heater lamp LP by a counter and the like. When the timer 46 starts the time measurement, the processing of the MFP 1 proceeds to Act 503. In Act 503, the timer 46 detects whether a predetermined time elapses. The predetermined time is set in advance, for example, as the time required for the temperature of the fixing roller 42 to reach the decolorizing temperature, and for the toner image of the sheet PJ to be heated and decolorized at the decolorizing temperature by the fixing roller 42. In Act 503, when the timer 46 detects the lapse of the predetermined time, the processing of the MFP 1 proceeds to Act 504. In Act 504, the timer 46 sends a control signal indicating that it detects the lapse of the predetermined time to the controller 41. When receiving the control signal from the timer 46, the controller 41 turns off the heater lamp LP. When the controller 41 turns off the heater lamp LP, the processing of the MFP 1 proceeds to Act 505. In Act 505, by displaying that the sheet P is in the jam state on a display 51, the MFP 1 alerts the operator, and prompts the operator to remove the sheet P in the jam state from the MFP 1.

The MFP according to the second embodiment described above heats the fixing roller to the decolorizing temperature by the heat source incorporated in the fixing roller when the sheet becomes the jam state in the vicinity of the fixing unit. The MFP decolorizes the toner image of the sheet in the jam state by heating the toner image to the decolorizing temperature by the fixing roller. Therefore, it is possible to reduce the discomfort of the operator when the operator removes the sheet in the jam state from the MFP.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a fixing unit configured to perform processing for fixing a toner image on a sheet by heating the toner image formed on the sheet at a fixing temperature, and processing for decolorizing a toner image by heating the toner image formed on a sheet at a decolorizing temperature higher than the fixing temperature;
a jam detection unit configured to detect that a sheet becomes a jam state in the fixing unit and a vicinity of the fixing unit; and
a controller configured to raise a heating temperature of the fixing unit to the decolorizing temperature and decolorize the toner image formed on the sheet in a jam state by the fixing unit when the jam state of the sheet is detected in a position of any one of the fixing unit and a vicinity of the fixing unit by the jam detection unit.

2. The image forming apparatus according to claim 1, wherein the jam detection unit detects that the sheet becomes the jam state in a conveyance path including the fixing unit and a vicinity of the fixing unit for conveying a sheet.

3. The image forming apparatus according to claim 2, wherein the jam detection unit detects the jam state of the sheet by measuring a conveyance time for the sheet being conveyed between a plurality of roller pairs disposed at a distance determined in advance in the conveying path.

4. The image forming apparatus according to claim 2, wherein the jam detection unit includes a detector disposed at an inlet portion through which a sheet enters the fixing unit in the conveyance path and an outlet portion through which a sheet exits from the fixing unit in the conveyance path, detecting that a sheet becomes the jam state in the fixing unit and a vicinity of the fixing unit.

5. The image forming apparatus according to claim 2, wherein the controller heats the sheet in the jam state at the decolorizing temperature by the fixing unit when the jam state of the sheet is detected in a position of any one of the fixing unit and the vicinity of the fixing unit by the jam detection unit.

6. The image forming apparatus according to claim 5,
wherein the fixing unit includes a heater configured to heat a toner image formed on a sheet, and
wherein the controller turns on the heater so as to increase a heating temperature of the fixing unit to the decolorizing temperature when a jam state of the sheet is detected in a position of any one of the fixing unit and the vicinity of the fixing unit by the jam detection unit.

7. The image forming apparatus according to claim 6, wherein the controller continues an on state of the heater for a predetermined time after a heating temperature of the fixing unit reaches the decolorizing temperature, and turns off the heater after the predetermined time elapses.

8. The image forming apparatus according to claim 7, further comprising a display configured to display the jam state of the sheet detected by the jam detection unit.

9. The image forming apparatus according to claim 8, wherein the controller displays the jam state of the sheet by the display after the predetermined time elapses when the jam state of the sheet is detected in a position of any one of the fixing unit and the vicinity of the fixing unit by the jam detection unit.

10. The image forming apparatus according to claim 9, wherein the controller displays the jam state of the sheet by the display without turning on the heater when the jam state of the sheet is detected in a position other than the fixing unit and the vicinity of the fixing unit by the jam detection unit.

11. An image forming apparatus comprising:
an exposure unit configured to form an electrostatic latent image on photoconductor;
a developing unit configured to form a toner image on the photoconductor by developing an electrostatic latent image formed on the photoconductor by the exposure unit using decolorizable toner;
a transfer unit configured to form a toner image on a sheet by transferring the toner image formed on the photoconductor by the developing unit to the sheet;
a fixing unit configured to perform processing for fixing the toner image on the sheet by heating the toner image formed on the sheet at a fixing temperature and processing for decolorizing the toner image by heating the toner image formed on the sheet at a decolorizing temperature higher than the fixing temperature;
a jam detection unit configured to detect that the sheet becomes a jam state in the fixing unit and a vicinity of the fixing unit; and
a controller configured to raise the heating temperature of the fixing unit to the decolorizing temperature, decolorizing the toner image formed on the sheet that becomes the jam state by the fixing unit.

12. The image forming apparatus according to claim 11,
wherein the fixing unit includes a fixing roller pressed against a face of the sheet on which a toner image is formed, and a press roller pressed against a face opposite to the face of the sheet with which the fixing roller is in contact, and
wherein the controller controls a temperature of the fixing roller so that the temperature of the fixing roller reaches the temperature of any one of the fixing temperature and the decolorizing temperature.

13. The image forming apparatus according to claim 12, wherein the jam detection unit detects the jam state of the sheet by measuring a conveyance time for the sheet being conveyed between a plurality of roller pairs disposed at a distance determined in advance in the conveying path for conveying the sheet.
